(19) United States
(12) Patent Application Publication
(10) Pub. No.: US 2017/0102956 A1
(43) Pub. Date: Apr. 13, 2017

(54) VIRTUAL MACHINE CUSTOMIZATION

(71) Applicant: Hewlett Packard Enterprise Development LP, Houston, TX (US)

(72) Inventors: Rupesh Shantamurty, Bangalore (IN); Vighneshwar Ganesh Bhat, Bangalore (IN)

(21) Appl. No.: 15/286,703

(22) Filed: Oct. 6, 2016

(30) Foreign Application Priority Data
Oct. 12, 2015 (IN) 5461/CHE/2015

(51) Int. Cl. G06F 9/455; G06F 9/445

(52) U.S. Cl. CPC G06F 9/45537; G06F 8/62

(57) ABSTRACT

A system comprising a processor, a profiling engine, a dependency module, and a customization module coupled to the processor for customizing a virtual machine is disclosed. Initially, the profiling engine obtains profiling data corresponding to the virtual machine. The profiling data lists active components determined to be involved in performing the function that the virtual machine is to perform. The dependency module determines dependent components utilized by the active components for implementing the functionality. The dependency module generates a dependency mapping. The dependency mapping maps the active components and the dependent components. Further, the customization module generates a list of retainable and non-retainable components. The retainable components are to be retained in the virtual machine and include the active components and dependent components. The non-retainable components are removed from the virtual machine for customizing the virtual machine.

### BACKGROUND

Virtual machines (VMs) have reshaped the field of computer based services due to its beneficial nature for individual users as well as large enterprises. The VMs allow virtualization of an actual physical computing system that may be used for implementing cloud computing networks and related services. Each VM may function as a self-contained platform, running its own operating system and software applications. Cloud computing customers are thus able to access various services and applications, such as firewalls and data storage without actually purchasing or implementing physical resources utilized for the services. Generally, each VM may perform a specific functionality for providing a service out of the various services provided by the cloud computing networks.

### BRIEF DESCRIPTION OF DRAWINGS

The detailed description is described with reference to the accompanying figures. It should be noted that the description and figures are merely example of the present subject matter and are not meant to represent the subject matter itself.

FIG. 1 illustrates a block diagram of a system for customizing a virtual machine, according to an example of the present subject matter.

FIG. 2 illustrates various example components of a system for customizing a virtual machine, according to an example of the present subject matter.

FIG. 3 illustrates an example method for customizing a virtual machine, according to an example of the present subject matter.

FIG. 4 illustrates an example method for customizing a virtual machine, according to another example of the present subject matter.

FIG. 5 illustrates an example network environment implementing a non-transitory computer readable medium for customizing a virtual machine, according to an example of the present subject matter.

### DETAILED DESCRIPTION

Virtual Machines (VMs) allow virtualization of an actual physical computing system, such as end user applications, firewalls, web servers, and data storage devices. The VMs may be utilized by cloud computing network and related networks for rendering various services to users by way of creating virtual environment of computing resources. Any user or subscriber may thus subscribe with a service provider who is providing a cloud computing network service and may interact with the VMs for using the service. Generally, each VM may perform a specific functionality for providing the service and the cloud computing network may thus have different VMs for performing different functionalities.

As VMs function as self-contained platforms running their own operating system, each VM is provisioned and installed with its own components, such as kernel libraries, software applications, and platform level components. During installation, each VM is loaded with a generic set of components irrespective of the specific functionality that the VM is to perform, after being provisioned. Loading the generic set of components, however, may result in un-optimized utilization of memory space, as significant memory space may be occupied by components that may never be utilized by the VM. Un-optimized utilization of the memory space may cause memory space crunch during the course of operation, thus involving regular memory management which may further lead to performance degradation of the VM. Having a large number of components may further increase security vulnerability of the VM as probability of hacking attacks will be high owing to availability of the large number of components.

To efficiently implement and maintain the VMs, a network provider may install a VM having minimum number of components that may be utilized by the VM for performing the specific functionality. One of the approaches for customizing a VM to have the minimum number of components includes manually identifying and uninstalling all surplus components from the VM. Manual identification and uninstallation of the surplus components may, however, require a system engineer to go through a list of installed components and identify the components that may be removed. Such a manual identification and removal process is a time utilizing process that may delay provisioning of the VMs. Further, since the manual identification and removal is based on the system engineer's expertise and intelligence, probability of error increases. For instance, useful components may get removed or some surplus components may remain installed.

Approaches for customizing virtual machines are described. The present approaches facilitate in dynamically customizing a virtual machine by removing surplus components which the virtual machine may not utilize for performing functionalities that are desired once the virtual machine has been initialized in a cloud based computing environment. As per an example of the present subject matter, the virtual machine is initially operated to perform the functionalities, and all components involved in the operation are determined and classified as active components. Subsequently, other dependent components utilized by the active components but not identified during the operation are determined. The active components and the dependent components are then designated as retainable components, while all other components installed in the virtual machine are determined as non-retainable components. Further, the non-retainable components are removed and the virtual machine is rebuilt without the non-retainable components to obtain a customized virtual machine having fewer components.

In accordance to an example of the present subject matter, a profiling tool is installed and executed in the virtual machine to identify the active components utilized when the virtual machine performs designated functionalities. Profiling data having a list of the active components, installed at different layers of software stack of the virtual machine, is thus obtained and stored. Further, association data having a mapping of associations between various components installed at different layers of software stack of the virtual machine is obtained.

Subsequently, dependent components that would he utilized by the active components for performing the functionalities but were not identified by the profiling tool are identified using the profiling data and the association data. A dependency mapping that maps the active components and the dependent components then generated based on the profiling data and association data. The active components and the dependent components are further designated as retainable components, i.e., the components that are utilized for performing the functionalities and thus have to be retained within the virtual machine. All other components installed in the virtual machine are determined as non-retainable components, i.e., the components that are not utilized for performing the functionalities and thus can be removed from the virtual machine. The non-retainable components are then removed from the virtual machine to obtain a customized virtual machine having fewer components. Further, the virtual machine is rebuilt with the non-retainable components removed. The customized virtual machine may be then provisioned and re tested to ensure that the virtual machine is performing the designated functionalities efficiently.

The present subject matter thus facilitates in dynamically customizing virtual machines. The virtual machines are customized by removing surplus components, i.e., the non-retainable components. Removing the non-retainable components facilitates in optimum utilization of the memory space of the virtual machine. Removal of the non-retainable components further helps in reducing the probability of security related attacks, thereby reducing security vulnerability of the virtual machine. Additionally, identifying the active components based on a real time operation of the virtual machine helps in avoiding errors, such as inclusion of surplus components as retainable components. The customization thus becomes more reliable as compared to the manual customization performed based on the system engineers expertise and intelligence. Further, determining the dependent components based on the association data helps in ensuring that any component, utilized for performing the designated functionality, but not identified along with the active components is not removed from the virtual machine.

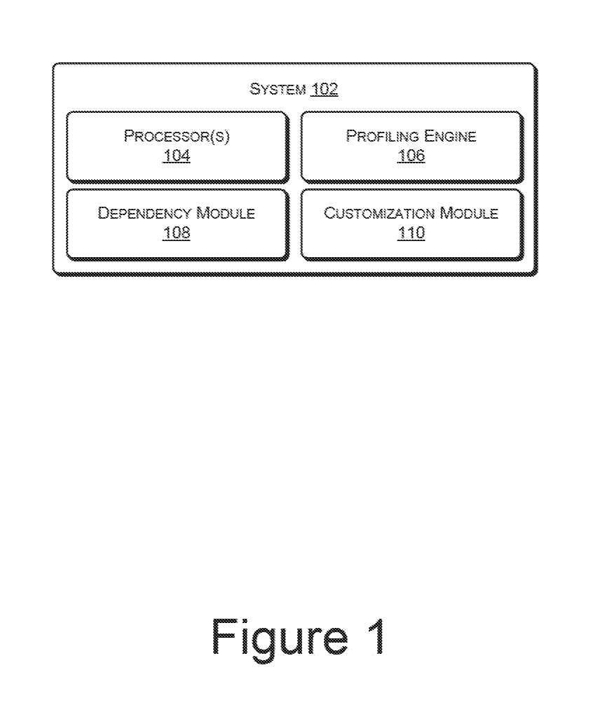

The present subject matter is further described with reference to FIGS. 1 to 5. It should be noted that the description and figures merely illustrate principles of the present subject matter. It is thus understood that various arrangements may he devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 102, according to an example of the present subject matter. The system 102 may be implemented for customizing a virtual machine in a cloud based computing environment. In one example, the system 102 may be a virtual machine hosted in the cloud based computing environment. In another example, the system 102 may be implemented in, for example, desktop computers, multiprocessor systems, personal digital assistants (PDAs), laptops, network computers, mainframe computers, and computing based devices in general.

The system 102 may include, for example, processor(s) 104, a profiling engine 106 coupled to the processor 104, a dependency module 108 coupled to the processor 104, and a customization module 110 coupled to the processor 104.

In operation, the profiling engine 106 may determine components that would be used by the virtual machine for performing designated functionalities upon installation. In one example, the profiling engine 106 obtains profiling data corresponding to the virtual machine that is being customized. The profiling data lists active components determined to be involved in performing the function that the virtual machine is to perform upon installation. The dependency module 108 may subsequently determine dependent components utilized by the active components for implementing the functionality and not identified in the profiling data. The dependency module 108 may generate a dependency mapping based on the profiling data and association data. The dependency mapping maps the active components and the dependent components.

Further, the customization module 110 may generate a list of retainable components and non-retainable components based on the dependency mapping and a list of installed components. The retainable components are the components that have to be retained in the virtual machine and include the active components and dependent components. The non-retainable components are the components that would be removed from the virtual machine for customizing the virtual machine.

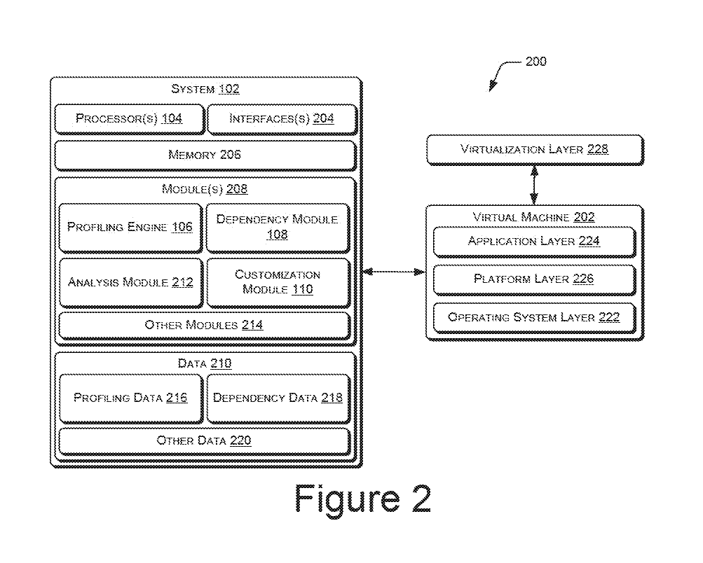

FIG. 2 illustrates various example components of a virtual machine customization system, hereinafter the system 102, according to an example of the present subject matter. In one example, the system 102 is hosted in a cloud based computing environment 200. As previously described, the system 102 may be hosted in the cloud based computing environment 200 for customizing a virtual machine, for example, a virtual machine 202 installed in the cloud based computer environment 200.

The system 102 includes the processor(s) 104, interface(s) 204, memory 206, module(s) 208, and data 210. The interfaces 204 may include a variety of commercially available interfaces, for example, interfaces for peripheral device(s), such as data input output devices, referred to as I/O devices, interface cards, storage devices, and network devices.

The memory 206 may be communicatively coupled to the processor 104 and may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The modules 208, amongst other things, include routines, programs, objects, components, and data structures, which perform particular tasks or implement particular abstract data types. The modules 208 may also be implemented as, signal processor(s), state machine(s), logic circuitries, and/or any other device or component that manipulate signals based on operational instructions. Further, the modules 208 can be implemented by hardware, computer-readable instructions executed by a processing unit, or by a combination thereof.

The module(s) 208 may include the profiling engine 106, the dependency module 108, an analysis module 212, the customization module 110, and other modules 214. The other modules 214 may include programs or coded instructions that supplement applications and functions, for example, programs in an operating system of the system 102. Further, the data 210 may include profiling data 216, dependency data 218, and other data 220.

As previously described, the present subject matter facilitates in dynamically customizing the virtual machine 202. In one example, the virtual machine 202 is customized by removing non-retainable components, i.e., surplus components of the virtual machine 202 that may not be utilized by the virtual machine 202 for performing a designed functionality. The non-retainable components may be removed from across different layers of software stack of the virtual machine 202. Examples of the different layers of software stack include operating system layer 222, application layer 224, and platform layer 226. The system 102 may further update a virtualization layer 228, associated with the virtual machine 202, for customizing the virtual machine 202.

In operation, upon receiving a customization request, the profiling engine 106 may access the virtual machine 202 for identifying the active components. In one example, the customization request may be received from a service provider installing and provisioning the virtual machine 202 for performing the desired functionality, say data storage. The virtual machine 202 may have various components, such as kernel libraries, software applications, and platform level components installed at different layers of the software stack. The profiling engine 106 initially accesses the virtual machine 202 to ascertain if the virtual machine 202 is running on a paravirtualized platform. In case the profiling engine 106 ascertains that the virtual machine 202 is running on a paravirtualized platform, the profiling engine 106 may load paravirtualization kernel components in the system 102. Loading the paravirtualization kernel components helps the system 102 to access and analyze the virtual machine 202. In case the profiling engine 106 ascertains that the virtual machine 202 is not running on a paravirtualized platform, the profiling engine 106 may not make any change in the system 102.

The profiling engine 106 subsequently installs and executes a profiling tool (not shown in the figure) in the virtual machine 202. In one example, the profiling engine 106 may be a software patch having a set of instructions for analyzing the virtual machine 202. Upon execution, the profiling tool may trigger the virtual machine 202 to operate for performing the function that the virtual machine 202 is to perform in real time upon installation. As the virtual machine 202 starts operating, the profiling tool observes and determines all instructions executed by the virtual machine 202 for performing the function. The profiling tool further identifies active components, from among various components, involved in executing the instructions within the virtual machine 202. In one example, the profiling tool may identify the active components based on the various system calls executed during application run, kernel modules executed for performing the function, and application call stack and application frameworks utilized for performing the function. Further, the active components may be installed at different layers of the software stacks of the virtual machine 202. The profiling tool may further generate profiling data listing the active components determined to be involved in performing the function that the virtual machine 202 is to perform upon installation.

The profiling data is then obtained by the profiling engine 106 and stored in the profiling data 216 for further processing. Subsequently, a list of installed components, i.e., the various components installed in the virtual machine 202 is obtained by the analysis module 212. In one example, the analysis module 212 may access the virtual machine 202 to execute an analysis tool for obtaining the list of the installed components. The analysis tool may access kernel of the virtual machine 202 to obtain the list of the installed components and provide the same to the system 102. The analysis module 212 may further save the list of installed components in the dependency data 218.

The analysis module 212 may further obtain association data having a mapping of associations between the various components. In one example, the association data may be a predefined data generated at the time of configuring the virtual machine 202 and may be saved in a database associated with the system 102. The association data may define the association between the various components, i.e., how different components are linked to each other and work in tandem for performing different operations.

In one example, the associations may be mapped across the layers of software stack and also within each layer of the software stack. For instance, a component at the platform layer 226 may be mapped with other components at the platform layer 226 as well as with the components at the application layer 224 and the operating system layer 222 with which the component has to interact during operation. The analysis module 212 may save the association data in the dependency data 218.

The association data and the profiling data are then used by the dependency module 108 to generate the dependency mapping. As previously described, the dependency mapping maps the active components and dependent components utilized by the active components for implementing the functionality of the virtual machine 202. The dependent components are thus the components that were utilized by the virtual machine 202 but were not identified in the profiling data. The dependent components are thus identified using the association data and the profiling data. In one example, the dependency module 108 initially analyses the profiling data to obtain the list of active components determined by the profiling tool.

The dependency module 108 may then analyze the association data to ascertain the components mapped to the active components. The dependency module 108 may then compare the list of components thus obtained with the active list to identify the dependent components that are not present in the list of active components. The dependent components thus identified are then mapped with the active components to generate the dependency mapping. Further, the dependency module 108 may save the dependency mapping in the dependency data 218.

Subsequently, a list of retainable components and non-retainable components is generated by the customization module 110. In one example, the list of retainable components and non-retainable components is generated based on the dependency mapping and the list of installed components. The retainable components are the components that are determined to have been utilized by the virtual machine 202 for performing the functionality and thus have to be retained for smooth operation of the virtual machine 202. The non-retainable components are the components that are determined to have not been utilized by the virtual machine 202 for performing the functionality and thus can be removed without affecting the operation of the virtual machine 202. In one example, the active components and the dependent components are determined to be the retainable components. The non-retainable components include components other than the active components and the dependent components, i.e., the components remaining in the list of installed components after removal of the active components and the dependent components. The customization module 110 may save the list of retainable components and non-retainable components in the dependency data 218.

Further, the customization module 110 may uninstall non-retainable components from the virtual machine 202 for customizing the virtual machine 202. For instance, unutilized software and libraries determined as non-retainable components maybe removed from the application layer 224 to customize the virtual machine 202. While, the utilized software and libraries determined as retainable components maybe retained within the application layer 224. In case of the platform layer 226, unutilized hardware tools determined as non-retainable components maybe removed, while utilized hardware tools determined as retainable components maybe retained. In case of the operating system layer 222, unutilized modules determined as non-retainable components maybe removed from the kernel, while utilized modules determined as retainable components maybe retained.

The customization module 110 may further rebuild the virtual machine 202 with the non-retainable components removed. In one example, the customization module 110 may rebuild and regenerate the virtual machine 202 using the retainable components, i.e., minimum components sufficient for smooth deployment and functioning of the virtual machine 202. For instance, the customization module 110 may rebuild the application layer 224, the platform layer 226, and the operating system layer 222 using utilized software, libraries, hardware tools, and modules determined as the retainable components for obtaining the customized virtual machine 202.

The customization module 11 may further provision the customized virtual machine 202 in the cloud based computing environment 200. Further, the system 102 may retest the virtual machine 202 to ensure that the virtual machine 202 is efficiently performing the designated functionality.

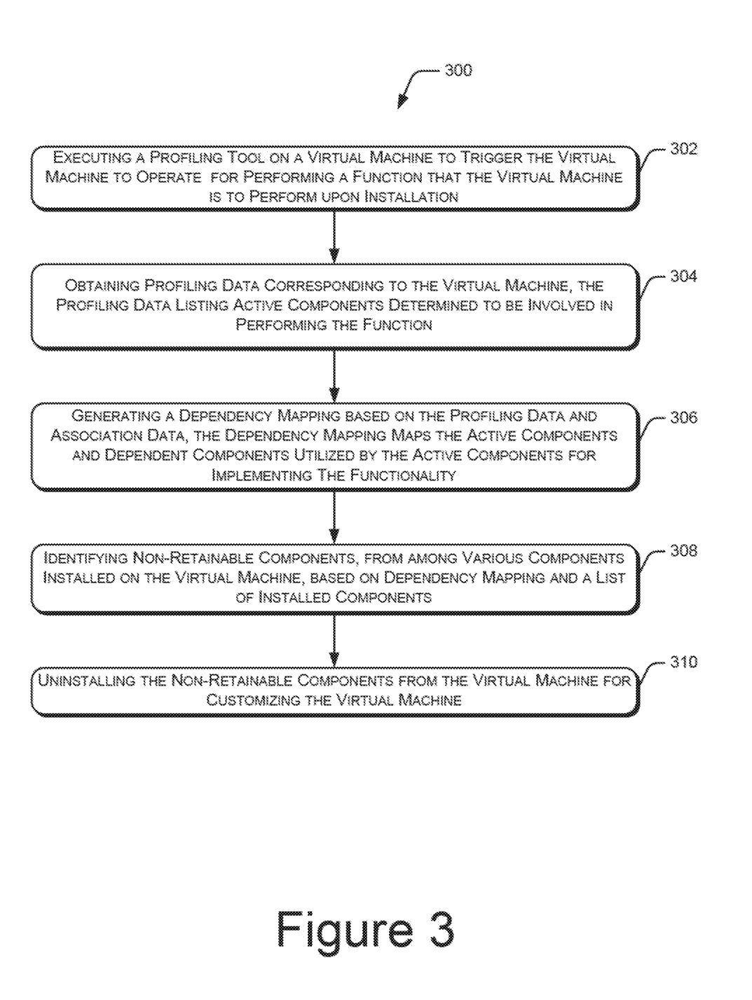

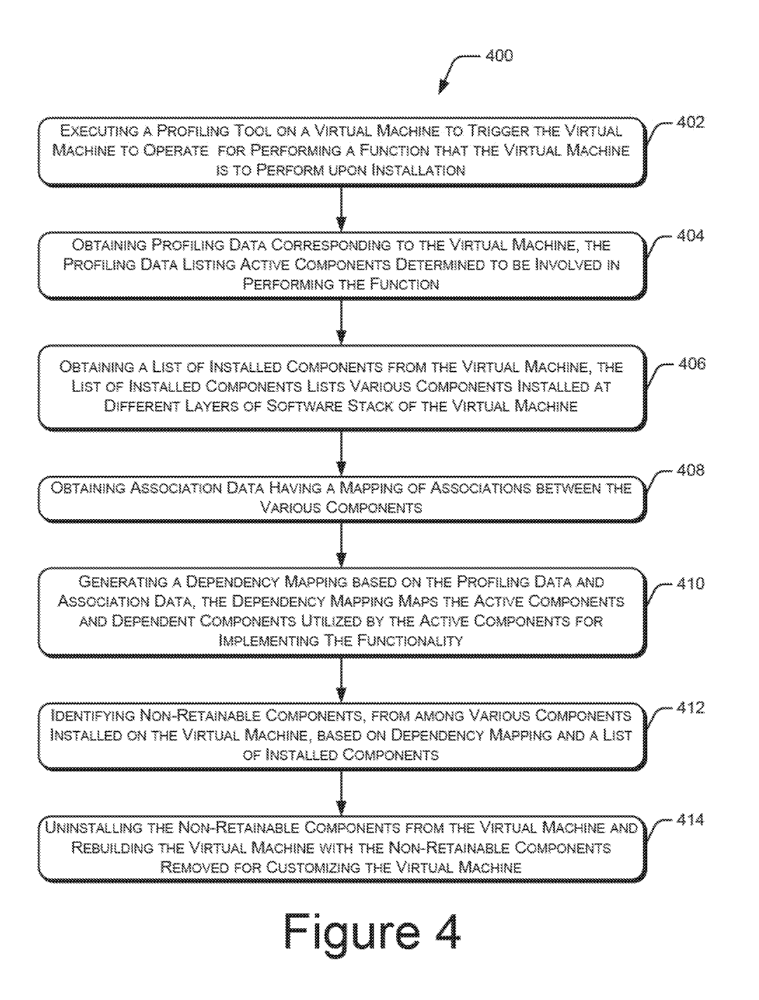

FIGS. 3 and 4 illustrate example methods 300 and 400, respectively, for customizing virtual machines, in accordance with an example of the present subject matter. The order in which the methods are described is not intended to be construed as a limitation, and any number of the described method blocks may be combined in any order to implement the aforementioned methods, or an alternative method. Furthermore, the methods 300 and 400 may be implemented by processing resource or computing device(s) through any suitable hardware, non-transitory machine readable instructions, or combination thereof.

It may also be understood that the methods 300 and 400 may be performed by computing systems, such as the system 102. Furthermore, the methods 300 and 400 may be executed based on instructions stored in a non-transitory computer readable medium, as will he readily understood. The non-transitory computer readable medium may include, for example, digital memories, magnetic storage media, such as one or more magnetic disks and magnetic tapes, hard drives, or optically readable digital data storage media.

Further, the methods 300 and 400 are described below with reference to the system 102 as described above, other suitable systems for the execution of these methods can be utilized. Additionally, implementation of these methods is not limited to such examples.

Referring to FIG. 3, at block 302, a profiling tool is executed on a virtual machine. In one example, the profiling tool is executed to trigger the virtual machine to operate for performing a function that the virtual machine is to perform upon installation. The profiling tool may be installed and executed by a virtual machine customization system, such as the system 102 on a virtual machine, such as the virtual machine 202 that has to be implemented in a cloud based environment for performing the function.

At block 304, profiling data corresponding to the virtual machine is obtained. In one example, the profiling data lists active components determined to be involved in performing the function. The active components are identified by the profiling tool as the components utilized by the virtual machine for performing the function. In one example, the active components are identified based on instructions executed during operation of the virtual machine. The active components thus identified are included in the profiling data and the profiling is then obtained by the system 102 for being used for customization of the virtual machine.

At block 306, dependency mapping is generated. In one example, the dependency mapping maps the active components and dependent components and is generated based on the profiling data and association data. The dependent components are components that are determined to have been utilized by the active components for implementing the functionality but not identified in the profiling data.

At block 308, non-retainable components are identified, from among various components installed on the virtual machine. The non-retainable components are the components other than the active components and dependent components and are determined to have not been utilized for functioning of the virtual machine. In one example, the non-retainable components are identified based on dependency mapping and a list of installed components.

At block 310, the non-retainable components are uninstalled from the virtual machine for customizing the virtual machine. In one example, the non-reliable components are removed from all levels of software stack of the virtual machine.

Referring to FIG. 4, at block 402, a profiling tool is executed on a virtual machine. In one example, the profiling tool is executed to trigger the virtual machine to operate for performing a function that the virtual machine is to perform upon installation. The profiling tool may be installed and executed by a profiling engine 106 of a virtual machine customization system, such as the system 102. The execution of the profiling tool may assist the profiling engine 106 to determine the components that would be used by the virtual machine to execute the designated functionalities.

At block 404, profiling data corresponding to the virtual machine is obtained as a result of the execution of the profiling tool. The profiling data lists active components determined to be involved in performing the function. In one example, initially, all instructions executed by the virtual machine for performing the function are determined. Subsequently, all active components involved in execution of the instructions are identified. The profiling data is then generated based on the identified active components.

At block 406, a list of installed components is obtained from the virtual machine. In one example, the list of installed components lists various components installed at different layers of software stack of the virtual machine. The different layers of the software stack may include, for example, application layer, platform layer, and operating system (OS) layer. Further, each of these layers may include varying components. For example, the application layer may include applications and libraries, the platform layer may include a web server, and the OS layer may include kernel modules.

At block 408, association data having a mapping of associations between the various components is obtained. The association data may define the relation between the various components. In one example, the association data may be a predefined data saved in a database associated with the system 102.

At block 410, a dependency mapping is generated based on the profiling data and the association data. The dependency mapping maps the active components and dependent components utilized by the active components for implementing the functionality. The dependent components are not identified in the profiling data and are thus identified using the associations mapped for the active components in the association data.

At block 412, non-retainable components are identified from among various components installed on the virtual machine. The non-retainable components are components other than the active components and dependent components and are determined to have not been utilized for functioning of the virtual machine. In one example, the non-retainable components are identified based on the dependency mapping and the list of installed components. Further, a list of retainable components and non-retainable components is generated. The retainable components are determined to have been utilized for functioning of the virtual machine and include the active components and the dependent components.

At block 414, the non-retainable components are uninstalled from the virtual machine. In one example, and the virtual machine is rebuilt with the non-retainable components removed and the retainable components retained.

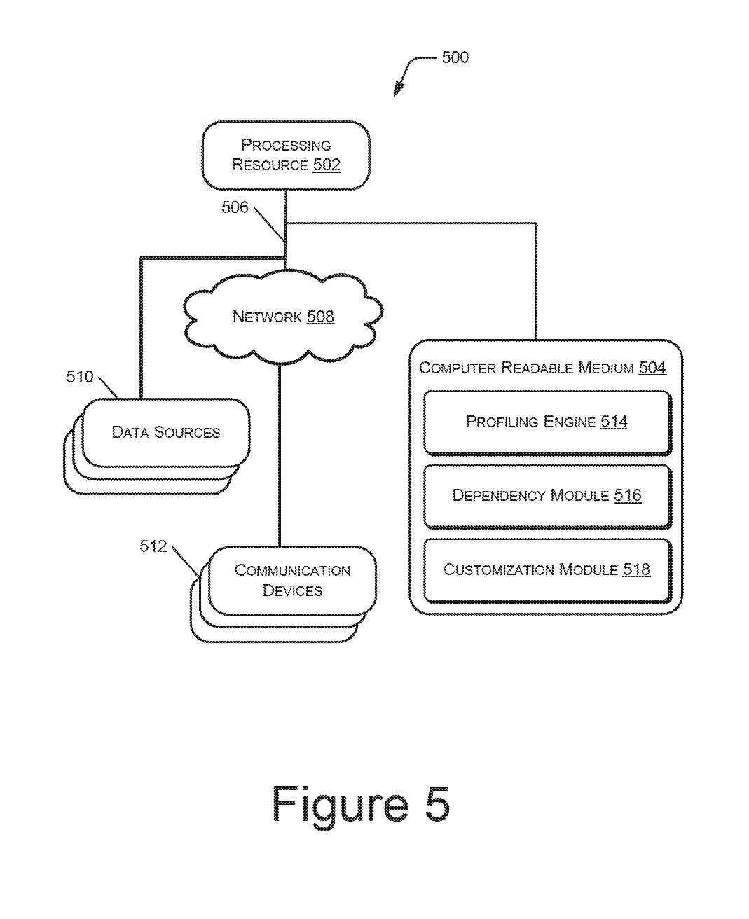

FIG. 5 illustrates an example network environment implementing a non-transitory computer readable medium for virtual machine customization, according to an example of the present subject matter. The system environment 500 may comprise at least a portion of a public networking environment or a private networking environment, or a combination thereof. In one implementation, the system environment 500 includes a processing resource 502 communicatively coupled to a computer readable medium 504 through a communication link 506.

For example, the processing resource 502 can include one or more processors of a computing device for file system replication. The computer readable medium 504 can be, for example, an internal memory device of the computing device or an external memory device. In one implementation, the communication link 506 may be a direct communication link, such as any memory read/write interface. In another implementation, the communication link 506 may be an indirect communication link, such as a network interface. In such a case, the processing resource 502 can access the computer readable medium 504 through a network 508. The network 508 may be a single network or a combination of multiple networks and may use a variety of different communication protocols.

The processing resource 502 and the computer readable medium 504 may also be coupled to requested data sources 510 through the communication link 506, and/or to communication devices 512 over the network 508. The coupling with the requested data sources 510 enables in receiving the requested data in an offline environment, and the coupling with the communication devices 512 enables in receiving the requested data in an online environment.

In one implementation, the computer readable medium 504 includes a set of computer readable instructions, implementing a profiling engine 514, a dependency module 516, and a customization module 518. The set of computer readable instructions can be accessed by the processing resource 502 through the communication link 506 and subsequently executed to process requested data communicated with the requested data sources 510 in order to facilitate customization of the virtual machine. When executed by the processing resource 502, the instructions of the profiling engine 514, dependency module 516, and customization module 516 may perform the functionalities described above in relation to the profiling engine 106, the dependency module 108, and the customization module 110, respectively.

For example, the profiling engine 514 may install and execute a profiling tool on the virtual machine to determine components that would be used by the virtual machine. In one example, profiling data may be obtained corresponding to the virtual machine being customized. The profiling data lists active components determined to be involved in performing a function that the virtual machine is to perform upon installation, In one example, the active components may be determined based on the execution of the profiling tool in the virtual machine. Subsequently, the dependency module 516 may identify dependent components utilized by the active components for performing the functionality and the dependent components are not identified in the profiling data. The dependency module may generate dependency based on the profiling data and association data. The association data includes a mapping of associations between various components installed at different layers of software stack of the virtual machine.

Further, the customization module 518 may generate a list of retainable components and non-retainable components based on the identification and a list of installed components. The retainable components are the components that have to be retained in the virtual machine and include the active components and the dependent components utilized by the active components. The non-retainable components are the components that have to be removed from the virtual machine for customizing the virtual machine. The non-retainable components are the components that are not utilized by the virtual machine for performing the designated functionalities. The non-retainable components may include unutilized or unrelated applications and libraries, kernel modules, etc.

The customization module 518 may then uninstall the on-retainable components from the virtual machine for customizing the virtual machine. The customization module 518 may further rebuild the virtual machine with the non-retainable components removed for customizing the virtual machine.

Although examples the present disclosure have been described in language specific to structural features and/or methods, it should stood that the appended claims are not necessarily limited to the specific features or methods described. Rather, the specific features and methods are disclosed and explained as examples of the present disclosure.

1. A system comprising:
a processor;
a profiling engine coupled to the processor to:
obtain profiling data corresponding to a virtual machine being customized, wherein the profiling data lists active components determined to be involved in performing a function that the virtual machine is to perform upon installation;
a dependency module coupled to the processor to:
generate a dependency mapping based on the profiling data and association data, wherein the dependency mapping maps the active components and dependent components utilized by the active components for implementing the functionality, wherein the dependent components are not identified in the profiling data; and
a customization module coupled to the processor to:
generate a list of retainable components and non-retainable components based on the dependency mapping and a list of installed components, wherein retainable components are the components that have to be retained in the virtual machine and include the active components and dependent components, the non-retainable components are the components that have to be removed from the virtual machine for customizing the virtual machine.

2. The system as claimed in claim 1, wherein the profiling engine further is to:
access the virtual machine to execute a profiling tool to trigger the virtual machine to operate for performing the function that the virtual machine is to perform upon installation; and
generate the profiling data based on the active components determined upon the execution of the profiling tool.

3. The system as claimed in claim 1, further comprising an analysis module coupled to the processor to:
obtain the list of installed components from the virtual machine, wherein the list of installed components includes a list of various components installed at different layers of software stack of the virtual machine; and
obtain the association data having a mapping of associations between the various components.

4. The system as claimed in claim 3, wherein the profiling engine further is to:
ascertain if the virtual machine is running on a paravirtualized platform; and
load paravirtualization kernel components in the system based on the ascertaining.

5. The system as claimed in claim 1, wherein the customization module further is to:
uninstall the non-retainable components from the virtual machine to customize the virtual machine;
rebuilding the virtual machine with the non-retainable components removed; and
provision the customized virtual machine.

6. A method comprising:
executing a profiling tool on a virtual machine to trigger the virtual machine to operate for performing a function that the virtual machine is to perform upon installation;
obtaining profiling data corresponding to the virtual machine, the profiling data listing active components determined to be involved in performing the function;
generating a dependency mapping based on the profiling data and association data, wherein the dependency mapping maps the active components and dependent components utilized by the active components for implementing the functionality, wherein the dependent components are not identified in the profiling data;
identifying non-retainable components, from among various components installed on the virtual machine, based on the dependency mapping and a list of installed components, wherein the non-retainable components are the components other than the active components and dependent components and are not utilized for functioning of the virtual machine; and
uninstalling the non-retainable components from the virtual machine or customizing the virtual machine.

7. The method as claimed in claim 6, wherein the obtaining profiling data further comprising:
determining all instructions executed by the virtual machine for performing the function;
identifying all active components involved in execution the instructions; and
generating the profiling data based on the identification.

8. The method as claimed in claim 6, wherein the method further comprising:
obtaining the list of installed components from the virtual machine, wherein the list of installed components includes a list of various components installed at the different layers of software stack of the virtual machine; and
obtaining the association data having a mapping of associations between the various components.

9. The method as claimed in claim 6, wherein the method further comprising:
rebuilding the virtual machine with the non-retainable components removed; and
provisioning the customized virtual machine.

10. The method as claimed in claim wherein the method further comprising:
generating a list of retainable components and the non-retainable components based on the identifying, wherein the retainable components are the components that have to be retained in the virtual machine and include the active components and dependent components.

11. A non-transitory computer readable medium having a set of computer readable instructions that, when executed, cause a processor to:
obtain profiling data corresponding to a virtual machine being customized, wherein the profiling data lists active components determined to be involved in performing a function that the virtual machine is to perform upon installation;
identify, based on the profiling data and association data, dependent components utilized by the active components for performing the functionality, wherein the dependent components are not identified in the profiling data, and wherein the association data includes a mapping of associations between various components installed at the different layers of software stack of the virtual machine;
generate a list of retainable components and non-retainable components based on the identification and a list of installed components, wherein retainable components are the components that have to be retained in the virtual machine and include the active components and the dependent components, the non-retainable components are the components that have to be removed from the virtual machine for customizing the virtual machine; and
uninstalling the non-retainable components from the virtual machine for customizing the virtual machine.

12. The non-transitory computer readable medium of claim 11 wherein the computer readable instructions, when executed, further cause the processor to:
access the virtual machine to execute a profiling tool to trigger the virtual machine to operate for performing the function that the virtual machine is to perform upon installation; and
generate the profiling data based on the active components determined upon the execution of the profiling tool.

13. The non-transitory computer readable medium of claim 11, wherein the computer readable instructions, when executed, further cause the processor to:
obtain the list of installed components from the virtual machine, wherein the list of installed components includes a list of various components installed at different layers of software stack of the virtual machine; and
obtain the association data having the mapping of associations between the various components.

14. The non-transitory computer readable medium of claim 11, wherein the computer readable instructions, when executed, further cause the processor to:
rebuild the virtual machine with the non-retainable components removed; and
provision the customized virtual machine.

15. The non-transitory computer readable medium of claim 11, wherein the computer readable instructions, when executed, further cause the processor to:
generate a dependency mapping based on the profiling data and association data, wherein the dependency mapping includes a mapping of the active components and the dependent components.
